(19) United States
(12) Patent Application Publication
(10) Pub. No.: US 2009/0155761 A1
(43) Pub. Date: Jun. 18, 2009

(54) Method for Producing Reticulocyte Lysate and Uses Thereof

(75) Inventors: William Hansen, San Francisco, CA (US); Vishwanath Lingappa, San Francisco, CA (US)

Correspondence Address: DAVID P. LENTINI, 53 Clark Road, North Berwick, ME, 03906-6310, US

(73) Assignee: Prosetta Corporation

(21) Appl. No.: 11/955,337

(22) Filed: Dec. 12, 2007

(51) Int. Cl. A01N 1/02

(52) U.S. Cl. 435/2

(57) ABSTRACT

Methods for producing substantially pure porcine reticulocyte lysate are provided. In one embodiment, the methods include inducing a reduction in the hematocrit of a pig to a level of between about 20% and about 25%; extracting at least a portion of blood from the pig; isolating a fraction of the blood containing substantially red blood cells; and preparing a porcine reticulocyte lysate preparation from the isolated fraction.

### 1 BACKGROUND OF THE INVENTION

1.1 Field of the Invention

The present invention relates to methods for obtaining biological materials useful for enabling cell-free biochemical processes and the materials so obtained. More specifically, the present invention provides methods for obtaining reticulocyte lysate from an animal and the resulting reticulocyte lysate for use in performing biochemical processes ex vivo. The invention has implications in biochemistry, molecular biology, virology, and medicinal chemistry.

1.2 The Related Art

The replication of intracellular biochemical processes has become central to modem biomedical and pharmaceutical research. Faithful ex vivo reproduction of the various chemical reactions and interactions that occur inside a cell enables careful observation and manipulation of reactions and interactions that cannot be achieved by working with whole cells or cellular lysates. Moreover, the ability to reproduce intracellular processes outside of the cell enables large scale, often robotic, experiments to screen of large numbers of chemical and biological substances for use as drugs. Also, ex vivo reproduction of the various chemical reactions and interactions that occur inside a cell allows easier production and retrieval of various biological substances compared to production in vivo (see, e.g., U.S. Pat. Nos. 6,399,323; 6,103,489; and 5,571,690).

A variety of methods and materials are used to create the necessary extracellular milieu necessary to mimic intracellular biochemical processes. Presently one of the most common materials used is rabbit reticulocyte lysate (“RRL”), which is available from commercial vendors such as Promega (Madison, Wis.). RRL can be used with a variety of modifications: Untreated RRL, i.e., RRL that has been treated to remove endogenous cells but not otherwise supplemented or modified, includes the intracellular biochemical components for protein synthesis (tRNA, ribosomes, amino acids, initiation, elongation and termination factors) and is used primarily for the isolation of these components and as a source of endogenous globin mRNA. RRL is also provided in other, more highly modified, forms for use in other applications. Examples of such modifications include the addition of hemin to enable translation of added mRNA templates; treatment with micrococcal nuclease and calcium to destroy endogenous mRNA (primarily mRNA encoding globin); calcium to remove globin mRNA; and supplementation with various amino acids. Typical uses of RRL include, but are not limited to: drug screening (e.g., determining how a drug affects translation rates), mutation and detection analysis (i.e., enzyme kinetics), protein-protein interactions (e.g., using glutathione-S-transferase or other fusion proteins), immunoprecipitation of protein complexes, ligand-binding region determination/confirmation/competition assays, protein structure analysis, electrophoretic mobility shift assays (EMSAs) for protein dna interactions, DNA footprinting and protein cross-linking studies, protein-RNA binding assays, post-translational modification tests, verification/characterization of cloned gene products, and protein oligomerization and/or assembly dimerization assays. These and other applications are familiar to those having ordinary skill in the art.

RRL is obtained by exsanguinating rabbits, which have relatively low volumes of blood. Thus, RRL is a relatively expensive material and often must be produced in batches collected from several rabbits, which creates a risk of contamination and loss of uniformity for replicating experiments. Thus, it would be preferable to develop other sources of the biochemical functions now provided by RRL that are more economical. The present invention meets these and other needs.

### 2 SUMMARY OF THE INVENTION

The present invention provides methods for obtaining reticulocyte lysate, and in some embodiments, porcine (pig) reticulocyte lysate (“PRL”), the porcine reticulocyte lysate so obtained, and methods and compositions using and including such porcine reticulocyte lysate. More specific exemplary embodiments are presented in Section 5.

In a first aspect, the invention provides methods for producing a substantially pure quantity of reticulocyte lysate from an animal. In some embodiments, the methods comprise: inducing a reduction in the hematocrit of a the animal to a level of between about 20% and about 25%; extracting at least a portion of blood from the animal; isolating a fraction of the blood containing substantially red blood cells; and preparing a reticulocyte lysate preparation from the fraction. In more specific embodiments, the inducing includes treating the animal with an effective amount of a phenylhydrazine reagent. In still more specific embodiments, the phenylhydrazine reagent is acetyl phenylhydrazine. In a still more specific embodiment, the inducing includes injecting the animal with the acetyl phenylhydrazine over a period of between about six days and about ten days. Yet more specific embodiments further include a rest period of between about one day and about three days following the inducing. In some embodiments, the animal is selected from the group consisting of pigs, horses, sheep, and cows. In more specific embodiments, the animal is a pig.

In another aspect, the methods of the present invention further comprise modifying the reticulocyte lysate preparation. More specific embodiment include adding hemin to the reticulocyte lysate preparation. Other more specific embodiments include depleting the concentration of at least one protein in the reticulocyte lysate preparation. Still other more specific embodiments include supplementing or depleting the concentration of at least one protein in the reticulocyte lysate preparation. Yet other more specific embodiments further include supplementing depleting the concentration of at least one amino acid in the reticulocyte lysate preparation.

Still other embodiments of the methods of the invention include removing substantially all hemoglobin from the reticulocyte lysate. Other embodiments of the methods of the invention include depleting substantially endogenous peroxidase or substantially inhibiting endogenous peroxidase activity. Still other embodiments further comprise supplementing the reticulocyte lysate with at least one agent effective to enable co-translational or post-translational protein modifications to the reticulocyte lysate. In more specific embodiments, the agent is selected from the group consisting of: membranes, organelles, subcellular fractions, proteins, inhibitors of enzymic pathways, stimulators of enzymic pathways, signal transduction pathways, and molecular chaperone pathways.

Yet more embodiments further comprise supplementing the reticulocyte lysate with one or more cytosols obtained from a source selected from the group consisting of: differentiated model cell cytosols, disease model cell cytosols, subcellular fractions, knock-out transgenic animals, and knock-in transgenic animals.

These and other aspects and advantages will become apparent when the Description below is read in conjunction with the accompanying Drawings.

### 3 BRIEF DESCRIPTION OF THE FIGURES

FIG. 1 shows the results of a cell-free translation demonstrating the utility of the porcine reticulocyte lysate of the present invention provided using a method in accordance with one embodiment of the invention.

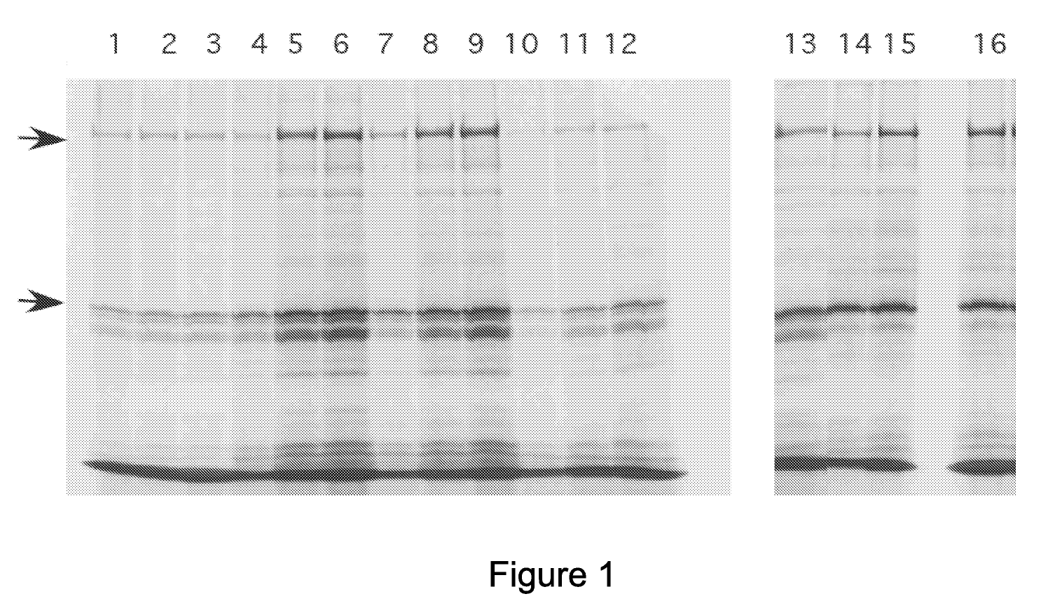

### 4 DESCRIPTION OF SOME EMBODIMENTS OF THE INVENTION

The present invention provides methods for collecting reticulocyte lysate from an animal. As used herein, “animal” includes any animal, and, more particular, animals having blood volumes greater than a rabbit's blood volume, including, but not limited to, pigs, horses, sheep, and cows. In some embodiments, the animal is a pig, and the invention provides methods for the collection of porcine reticulocyte lysate (“PRL”) and the resulting PRL so collected. The PRL provided by the present invention has at least the same utility as RRL, but, since pigs have such larger blood volume, can be produced in greater quantities and at lower cost than RRL. Thus the present invention provides an important component for ex vivo reproduction of critical biochemical processes that has greater uniformity at lower cost. However, the methods described and illustrated here can be adapted to any animal, especially, horses, sheep, and cows, to provide the reticulocyte lysate for the corresponding species.

In a first aspect, the present invention provides methods for obtaining reticulocyte lysate. In some embodiments, the reticulocyte lysate is produced by a process comprising: inducing a reduction in the hematocrit of an animal (e.g., a pig) to a level of between about 20% and about 25%. Generally for a pig, the hematocrit will start at a level of between about 40% and about 45%, and treatment will take between about six days and about ten days. The reduction of hematocrit can be performed using any methods and materials known to those having ordinary skill in the art. A more specific embodiment includes treating the animal (e.g., a pig) with an effective amount of a phenylhydrazine reagent to induce the reduction in hematocrit. In a still more specific embodiment, the phenylhydrazine reagent is acetyl phenylhydrazine, which is known to those having ordinary skill in the art and available from commercial sources (e.g., Sigma Chem. Co., St. Louis, Mo.). In one embodiment, the hematocrit of the treated animal (e.g., a pig) is monitored periodically, e.g., every second day, to determine when the hematocrit reaches a level of between about 20% and about 25%. During the monitoring period, the hematocrit may fall and then rise briefly (e.g., to about 35%), and then fall into the target range. A more specific embodiment includes injecting the animal (e.g., a pig) with said acetyl phenylhydrazine over a period of between about six days and about ten days; and, more specifically, further including a rest period during which the hematocrit is not reduced, e.g., the acetyl phenylhydrazine is not injected, of between about one day and about three days following the day when the hematocrit reaches a level of between about 20% and about 25%.

The method of the invention further includes extracting at least a portion of blood from the animal. In one embodiment, the animal is a pig and the extraction is performed when the hematocrit reaches a level of between about 20% and about 25%. Extraction can be of any quantity of blood from the animal, including, but not limited to substantial ro complete exsanguination. Procedures for performing such bloodletting, including exsanguination, are familiar to those having ordinary skill in the art. The extracted blood is collected for processing or storage using methods and materials known to those having ordinary skill in the art. In one embodiment, prior to bloodletting the animal is treated to reduce blood coagulation using methods known to those having skill in the art. In one more specific embodiment, the animal is injected with heparin. In more specific embodiments, the heparin is combined with chloral hydrate or ketamine. In more specific embodiments, the animal is a pig. The details of such treatments and combinations will be familiar to those having ordinary skill in the art. Collection can be performed by puncturing the animal's aorta or superior vena cava (or both) after allowing sufficient time for the anticoagulation treatment, if performed, to take substantial effect. The blood is collected (e.g., using buckets) and allowed to chill for a period (e.g., between about 30 minutes and about 60 minutes). Performing such procedures is familiar to those having ordinary skill in the art.

Following collection, in some embodiments the blood is then processed to remove the plasma and, in more specific embodiments, the buffy coat (including white blood cells), to enrich the concentration of red blood cells. Such removal can be achieved using methods known to those having skill in the art. For example, the collected blood can be spun at a rotational velocity of 2,500 revolutions per minute (rpm), about 1,800 g, for about ten minutes at a temperature of about 4° C., followed by aspiration of the plasma and buffy coat. The spinning described herein can be performed using any suitable centrifuge, such as a Beckman JS4.2 rotor (available commercially from Beckman Coulter, Fullerton, Calif.) or similar apparatus. Still other methods for enhancing blood cell content will be apparent to those having ordinary skill in the art.

In other embodiments, the method of the invention includes isolating a fraction of the blood containing substantially red blood cells, such as exemplified above, and preparing a reticulocyte lysate preparation from that fraction. Methods and materials for making such a lysate preparation will be familiar to those having ordinary skill in the art. For example, in one embodiment in which the animal is a pig, the red blood cells produced using the exemplary method described above are resuspended in three volumes of a phosphate buffered saline (PBS) solution that includes magnesium sulfate (MgSO₄) and glucose by sufficient swirling, stirring, or shaking at a temperature of about 4° C. In a more specific example, the PBS solution includes MgSO₄ (3.25 mM) 50:1 of 162 mM, 20 ml of 40 g/l of MgSO4-7H₂O per liter of glucose (5.5 mM) 2 ml of 50% (2.77 M) glc per liter. The resulting mixture is spun at about 2,500 rpm (1,800 g) for about ten minutes at a temperature of about 4° C. The re-packed blood cells so produced are then resuspended by gentle swirling in three volumes of PBS at about 4° C. and spun at a rate of about 4,200 rpm in for about ten minutes at 4° C. (about 5,000 g). This sequence of spinning and resuspending can be repeated as needed to achieve a desired degree of washing. In some embodiments, the cells are washed about three times using this sequence. Such operations can be performed using methods, materials, and equipment known to those having ordinary skill in the art. Furthermore, other methods for achieving these results for pigs and other animals will be apparent to those having ordinary skill in the art.

In more specific embodiments, the thrice washed cells described above are resuspended in an approximately equal volume of ice cold distilled water and resuspended (e.g., by vigorous shaking for about two minutes). The solution is then left to chill, e.g., for about five minutes on ice, and then shaken again vigorously for about five minutes. The cells are then spun at a rate of about 4,200 rpm (5,000 g), or a substantial equivalent, for about thirty minutes at a temperature of about 4° C. to produce the desired lysate of the invention. In still more specific embodiments include adding hemin to said reticulocyte lysate preparation. In some embodiments, the animal is a pig. Methods for achieving these results for other animals will be apparent to those having ordinary skill in the art.

In yet other embodiments, the method of the invention includes depleting or supplementing (or both) the concentration of at least one protein in said porcine reticulocyte lysate preparation. In other embodiments, the method of the invention includes supplementing or depleting (or both) the concentration of at least one amino acid in said porcine reticulocyte lysate preparation. Both of these embodiments can be prepared using the methods and materials described herein and methods and materials known to those having ordinary skill in the art. In one embodiment, about 40 ml of a 10 mg/ml hemin solution is added to each liter of lysate and the mixture swirled to achieve substantially complete mixing. The resulting solution can be used or modified as any reticulocyte lysate reagent is used or modified, or stored. In one embodiment, the lysate is stored in aliquots of about 40 ml of lysate in a 50 ml falcon tube, flash frozen in liquid nitrogen, and stored at a temperature of about −80° C. In some embodiments, the animal is a pig. Methods for achieving these results for other animals will be apparent to those having ordinary skill in the art.

In a second aspect, the present invention provides porcine reticulocyte lysate, and, more particularly, the reticulocyte lysate produced using the methods and materials provided by the present invention. In some embodiments, the reticulocyte lysate provided by the present invention is modified by the addition or removal of various substances (or both). The knowledge of which substances to add and remove will depend on the application for the lysate of the invention and can be done using methods and materials known to those having ordinary skill in the art. For example, unwanted proteins can be removed using any combination of biochemical and antibody extraction techniques as will be understood by persons having ordinary skill in the art. Alternatively, additional proteins, mRNA for transcriptions, and amino acids can be added.

In some embodiments of the invention, substantially all hemoglobin is removed from the reticulocyte lysate. In other embodiments, substantially all endogenous peroxidases are removed, or the activities of substantially all endogenous peroxidases are substantially inhibited, or both. Methods for achieving such removal and inhibition will be familiar to persons having ordinary skill in the art.

In other embodiments, the porcine reticulocyte lysate is supplemented with at least one agent effective to enable co-translational or post-translational protein modifications to said porcine reticulocyte lysate. Examples of such agents include without limitation: membranes, organelles, subcellular fractions, proteins, inhibitors of enzymic pathways, stimulators of enzymic pathways, signal transduction pathways, and molecular chaperone pathways. Methods for achieving such supplementation and suitable agents are known to persons having ordinary skill in the art.

In yet other embodiments, the porcine reticulocyte lysate is supplemented with one or more cytosols obtained from a source selected from the group consisting of differentiated model cell cytosols, disease model cell cytosols, subcellular fractions, knock-out transgenic animals, and knock-in transgenic animals. The methods for achieving such supplementation and suitable cytosols are known to persons having ordinary skill in the art.

### 5 EXAMPLES

The following Examples are provided to illustrate certain aspects of the present invention and to aid those of skill in the art in the art in practicing the invention. These Examples are in no way to be considered to limit the scope of the invention in any manner.

### 5.1 Pig Reticulocyte Lysate Production Protocol

### 5.1.1 Procedure

Four pigs (numbered 1-4, weighing approximately 100 Kg each) were each injected with about 75 ml of acetyl phenylhydrazine subcutaneously into their loose neck skin daily for between six days and ten days, followed by two days of rest (no injections). During the injection period the pigs' hematocrits were monitored on alternating days, with a goal of observing a hematocrit fall from a level of between about 40% and about 45% to a level of between about 20% and about 25% on the day of exsanguination. A pattern of reduction in hematocrit, followed by partial recovery, and then a greater reduction, was observed: reductions in their hematocrits from approximately 40-45% were followed by subsequent partial recoveries, e.g. to about 35%, which then fell again. (Without being bound to any particular theory of action, the partial recovery may be due to extramedullary hematopoiesis.)

The pigs were exsanguinated on the third day after completion of the injections. They were harvested serially, with two teams working simultaneously, but offset in time by a period from about 30 minutes to about 60 minutes, using the following procedure.

Each pig was injected with an amount of heparin and chloral hydrate or ketamine cocktail sufficient to substantially reduce blood coagulation. When animal went down, it was hoisted and exsanguinated (by puncture of the aorta followed by superior vena cava) into a bucket that had been placed within a larger bucket of ice-slush. The warm heparinized blood was left to chill for between about 30 minutes and about 60 minutes. The chilled blood was spun in a centrifuge at a rate of about 2,500 rpm (Beckman JS4.2 rotor, 1800 g) for about ten minutes at 4° C., after which the plasma (and white cell-containing buffy coat) was aspirated to leave packed blood cells. Approximately 4-6 liters of blood was collected from each pig.

The packed red cells were resuspended by gentle swirling in about three volumes of PBS containing MgSO₄ and glucose at 4° C.: MgSO₄ (3.25 mM) 50:1 of 162 mM, 20 ml of 40 g/L of MgSO₄-7H₂O per liter glucose (5.5 mM) 2 ml of 50% (2.77 M) glc per liter. The suspension was centrifuged at 2,500 rpm (Beckman JS4.2 rotor) for ten minutes at 4° C. (1800 g) having a glucose concentration of about five mM (1.7 g/liter or 3.3 ml of 50% glucose/liter PBS) at 4° C. and centrifuged a second time at 4° C. This procedure was repeated a total of three times, always at 4° C.

The packed washed cells were again resuspended in three volumes of PBS (4° C.) and spun at approximately 4,200 rpm (Beckman JS4.2 rotor) for ten minutes at 4° C. (5,000 g).

The packed washed cells were then resuspended in approximately equal volumes of ice-cold distilled water and shaken very vigorously for about two minutes. The shaken cells were then allowed to sit for five minutes on ice and then shaken vigorously for about five minutes, after which they were spun in a centrifuge at a rate of about 4,200 rpm for about 30 minutes at approximately 4° C. (5,000 g). The resulting lysate was then collected.

For hemin supplemented lysate, hemin was then added to the lysate (40 ml of 10 mg/ml hemin per liter of lysate) and swirled to mix the hemin and lysate. Aliquots of the hemin-lysate mixture (40 ml in a 50 ml falcon tube) were flash frozen in liquid nitrogen and stored at −80° C.

### 5.1.2 Preparation of Acetylphenylhydrazine

Approximately 2.5 g acetylphenylhydrazine (obtained commercially form Sigma, St. Louis Mo.) was mixed with ethanol (20 ml) and distilled water (50 ml-60 ml). Approximately 1 ml of f10 N KOH was added to bring the pH of the solution to about seven and more distilled water was added to make about 100 ml of solution volume. Note that 2× acetylphenylhydrazine can be prepared with gentle warming of the ethanol solution in order to achieve a more concentrated stock solution allowing injection of smaller volumes into the pig.

### 5.1.3 Preparation of Hemin

About 6.44 mg hemin (bovine crystalline type I, Sigma, St. Louis Mo.) was mixed with about 0.25 ml of 1 N KOH, about 0.5 ml of 0.2 M Tris at a pH of between about seven and about 8, about 8.9 ml of ethylene glycol, about 0.19 ml of 1 N HCl, and about 0.05 ml distilled water. The final pH was adjusted to a value between about seven and about eight. The resulting preparation was stored at −20° C.

### 5.2 Analysis of Porcine Reticulocyte Lysate Produced by the Methods of the Invention

A cell-free translation containing ³⁵S methionine was carried out as previously described (Shields 1978 (and references therein); Perara, 1986) using reactions supplemented with either pig reticulocyte lysate provided using the methods of the invention described above (PRL, lanes 1-13) or rabbit reticulocyte lysate obtained from conventional sources (RRL, lanes 14-16). The Figure shows lysate pre-desalting (lanes 1-3), desalted (lanes 4-6), digested winuclease after desalting (lanes 7-9, 13), and digested with 10× nuclease (10-12). Lanes 11-12 are pig #3 and lane 13 is pig #4. The translation products shown are for a combination of Ebola NP nucleoprotein (upper arrow head) and Venezuelan Equine Encephalitis Virus nucleoprotein (VEEV) nucleoprotein (lower arrow head), representing approximately 80 kDa and 30 kDa proteins. Also shown are reactions in which the proportion of reticulocyte lysate added of each type represents 20% (lanes 1, 4, 7, 10), 35% (lanes 2, 5, 8, 11, 13) and 50% (lanes 3, 6, 9, 12) of the total translation volume.

As can be seen, prominent bands of the size of Ebola NP and VEEV core are observed at 35% and 50% lysate for pig #4 and rabbit, and 35% of pig #3. The intensity of the pig #4 Ebola NP band (lanes 5, 6, 8,9) is slightly more intense than the corresponding band of rabbit, demonstrating that pig#4 reticulocyte lysate compares favorably to the rabbit lysate. Surprisingly, the results of this early, i.e., unoptimized, PRL protocol are comparable, if not better than, the best results obtained using RRL.

### 6 CONCLUSION

Although various specific embodiments and examples have been described herein, those having ordinary skill in the art will understand that many different implementations of the invention can be achieved without departing from the spirit or scope of this disclosure. For example, many operating parameters other than those described herein will be effective to achieve the results of the invention and are within the scope of the invention. Still other variations will be clear to those having ordinary skill in the art.

### 7 BIBLIOGRAPHY

The following references are incorporated herein by reference in their entirety and for all purposes.
Perara, E., Rothman, R. E., et al. (1986). “Uncoupling translocation from translation: implications for transport of proteins across membranes.” Science 232(4748):348 52.
Shields D., Blobel G. (1978). “Efficient cleavage and segregation of nascent presecretory proteins in a reticulocyte lysate supplemented with microsomal membranes.” J Biol Chem. 253(11):3753-3756.

What is claimed:

1. A method for producing a substantially pure quantity of reticulocyte lysate from an animal, comprising:
inducing a reduction in the hematocrit of a said animal to a level of between about 20% and about 25%;
extracting at least a portion of blood from said animal;
isolating a fraction of said blood containing substantially red blood cells; and
preparing a reticulocyte lysate preparation from said fraction.

2. The method of claim 1, wherein said inducing includes treating said animal with an effective amount of a phenylhydrazine reagent.

3. The method claim 2, wherein said phenylhydrazine reagent is acetyl phenylhydrazine.

4. The method of claim 3, wherein said inducing includes injecting said animal with said acetyl phenylhydrazine over a period of between about six days and about ten days.

5. The method of claim 4, further including a rest period of between about one day and about three days following said inducing.

6. The method of claim 1, further including modifying said reticulocyte lysate preparation.

7. The method of claim 6, further including adding hemin to said reticulocyte lysate preparation.

8. The method of claim 6, further including depleting the concentration of at least one protein in said reticulocyte lysate preparation.

9. The method of claim 6, further including supplementing the concentration of at least one protein in said reticulocyte lysate preparation.

10. The method of claim 6, further including supplementing the concentration of at least one amino acid in said reticulocyte lysate preparation.

11. The method of claim 6, further including depleting the concentration of at least one amino acid in said reticulocyte lysate preparation.

12. The method of claim 1, further comprising removing substantially all hemoglobin from said reticulocyte lysate.

13. The method of claim 1, further comprising substantially depleting endogenous peroxidase or substantially inhibiting endogenous peroxidase activity.

14. The method of claim 1, further comprising supplementing said reticulocyte lysate with at least one agent effective to enable co-translational or post-translational protein modifications to said reticulocyte lysate.

15. The method of claim 14, wherein said at least one agent is selected from the group consisting of: membranes, organelles, subcellular fractions, proteins, inhibitors of enzymic pathways, stimulators of enzymic pathways, signal transduction pathways, and molecular chaperone pathways.

16. A substantially pure quantity of a modified reticulocyte lysate produced by the method of claim 14.

17. The method of claim 1, further comprising supplementing said reticulocyte lysate with one or more cytosols obtained from a source selected from the group consisting of: differentiated model cell cytosols, disease model cell cytosols, subcellular fractions, knock-out transgenic animals, and knock-in transgenic animals.

18. The method of claim 1, wherein said animal is selected from the group consisting of pigs, horses, sheep, and cows.

19. The method of claim 19, wherein said animal is a pig.

20. A substantially pure quantity of reticulocyte lysate produced by the method of claim 1.
